(19) United States
(12) Patent Application Publication
(10) Pub. No.: US 2005/0128758 A1
(43) Pub. Date: Jun. 16, 2005

(54) Light fixture

(76) Inventor: Ronald E. Brick, Winnipeg (CA)

Correspondence Address: ADE & COMPANY, 1700-360 MAIN STREET, WINNIPEG, MB, R3C3Z3, CA

(21) Appl. No.: 10/932,320

(22) Filed: Sep. 2, 2004

Related U.S. Application Data
(60) Provisional application No. 60/499,019, filed on Sep. 2, 2003.

(51) Int. Cl. F21V 23/04; F21V 21/10

(52) U.S. Cl. 362/411; 362/276; 362/395

(57) ABSTRACT

A light fixture has a pipe of constant diameter shaped to define a vertical stand portion, an arched upper section and a hanging portion which extends downwardly from the arched upper section generally parallel to the stand portion. A mounting plate is attached at or adjacent the bottom of the stand portion on one side of on the bottom for attachment of the stand portion to a support surface. A wire passes through the pipe for supplying electric power to a lamp and photocell attached to the hanging portion.

### FIELD OF THE INVENTION

The present invention relates to a light fixture for mounting to a surface.

### BACKGROUND

Lighting arrangements for decks and other outdoor surfaces need to provide a suitable support for the light as well as being convenient for mounting purposes. Lighting arrangements also have to be aesthetically pleasing and provide suitable lighting for the surrounding area.

Many different designs and arrangements are previously available but there remains a requirement for an improved arrangement which holds the lamp conveniently and provides a suitable mounting for attachment to exterior surfaces.

### SUMMARY

It is one object of the present invention to provide an improved light fixture.

According to the present invention there is provided a light fixture comprising:
a pipe of constant diameter shaped to define a vertical stand portion;
an arched upper section and a hanging portion which extends downwardly from the arched upper section generally parallel to the stand portion;
a mounting plate attached at or adjacent the bottom of the stand portion for attachment of the stand portion to a support surface;
a wire passing through the pipe for supplying electric power, and;
a lamp attached to the hanging portion for receiving the electric power.

In one arrangement the mounting plate is on one side of the stand portion parallel thereto.

In one arrangement the mounting plate is on the bottom of the stand portion at right angles thereto.

In one arrangement the wire extends through the open end of the stand portion and through the mounting plate.

In one arrangement the wire extends through an opening in the side of the stand portion above the mounting plate.

Preferably on the end of the hanging portion is mounted a fitting carrying a lampshade support dish to which a lamp shade is attached.

Preferably the lampshade support dish receives therein a photocell assembly.

Preferably the photocell assembly surrounds the fitting.

Preferably the photocell assembly is generally annular.

Preferably the lampshade support dish has a hole therethrough exposing a light receptor of the photocell assembly.

### BRIEF DESCRIPTION OF THE DRAWINGS

In the accompanying drawings, which illustrate an exemplary embodiment of the present invention:

FIG. 1 is an isometric view of a first embodiment of light fixture according to the present invention.

FIG. 2 is a side elevational view of a light fixture according to present invention.

FIG. 3 is a vertical cross section of an arrangement similar to that of FIG. 2.

FIG. 4 is a side elevational view of a further light fixture according to the present invention.

FIG. 5 is a cross-sectional view of the lamp and adjacent end of the tube of the embodiments shown above including an optional photocell for operating the lamp when the ambient light drops.

### DETAILED DESCRIPTION

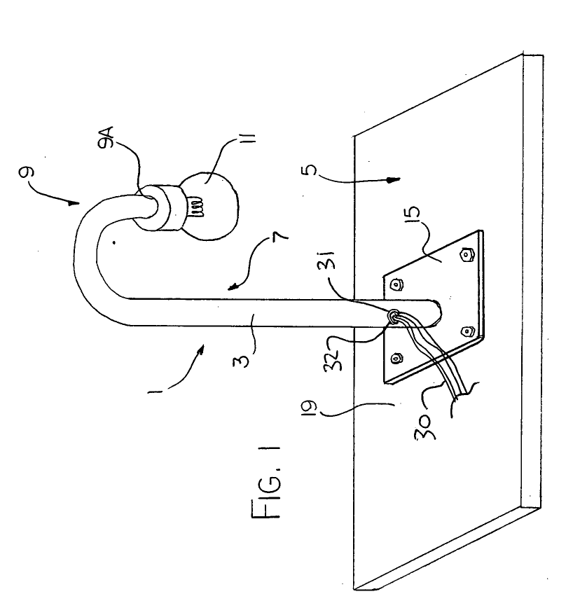

As illustrated in FIG. 1 through 3, a light fixture 1 designed for mounted in fences, houses, garages, decks, concrete and stucco walls, picnic tables and the like. The fixture has a main elongate body 3 which is arranged to extend from a surface 5. The elongate body is a hollow pipe of constant diameter shaped to define a vertical stand portion 7. A first end 9 of the body is arched and extends to hang downwardly from the arch generally parallel to the main body. At a furthermost end 9A of the first end a light 11 is arranged to be fixed thereto such that the light is positioned beside the vertical stand portion for illumination of the desired area.

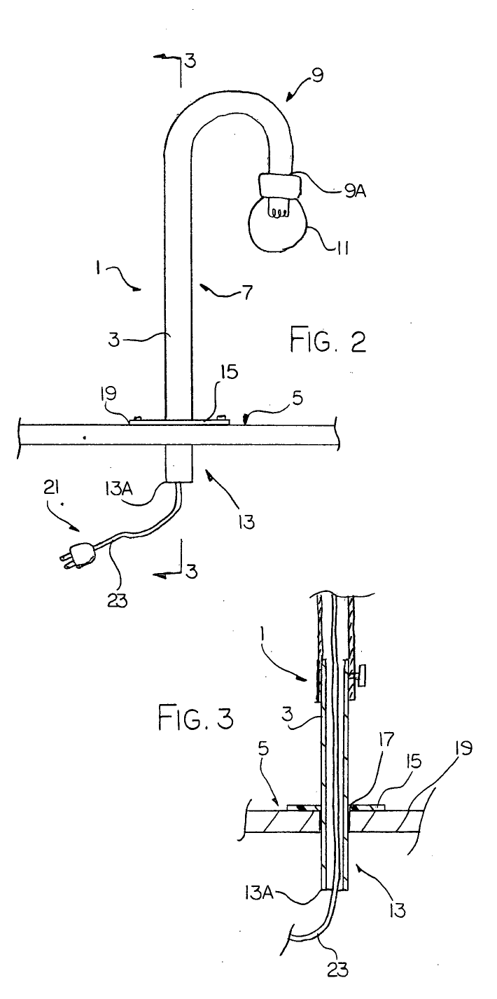

A second end 13 of the elongate body is arranged for mounting to a surface. A mounting plate 15 attached to the second end is arranged to mounting to the surface. FIGS. 2 and 3 show the second end inserted through a hole 17 drilled in the surface and the mounting plate fastened to a top side 19 of the surface. A furthermost end 13A of the second end is hidden beneath or behind the surface such that a power supply 21 extending from the second end is hidden as well.

The power supply consists of a wire 23 which passed through the pipe for supplying electric power to the light.

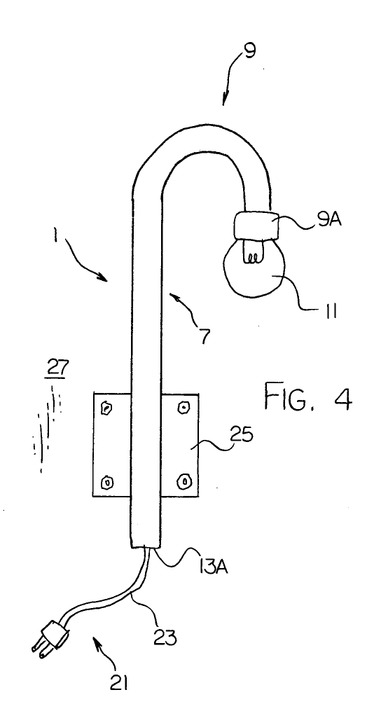

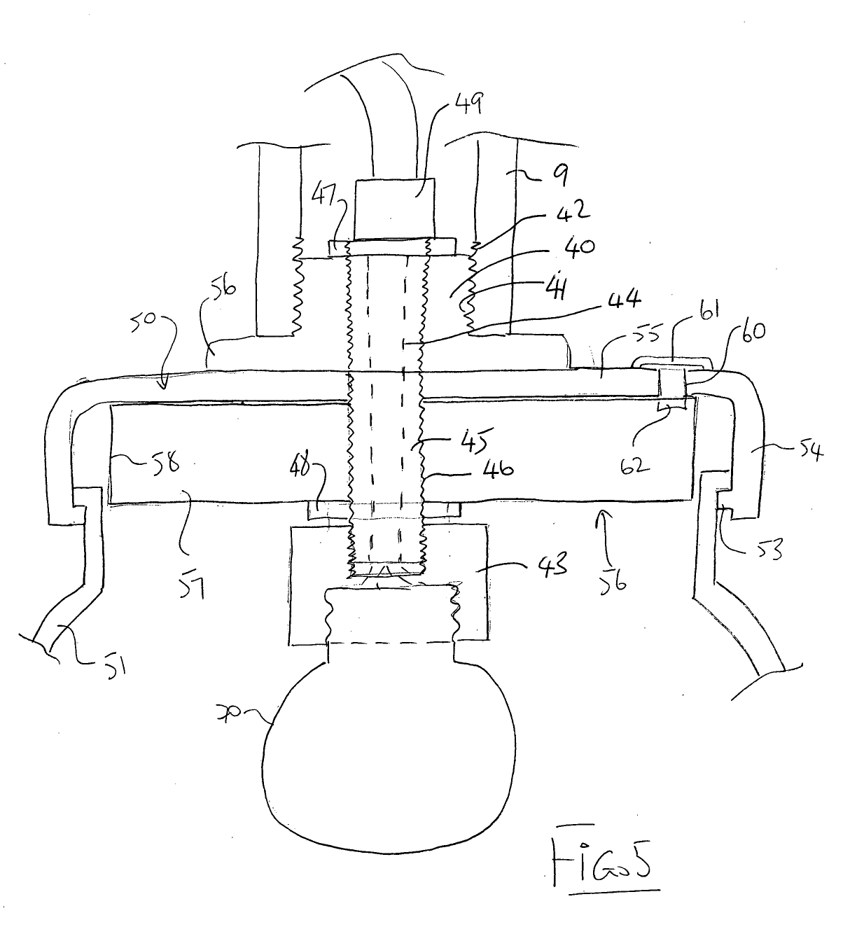

In a second embodiment of the present invention there is illustrated, in FIG. 4, a wall mount plate 25 which is arranged to mount vertically on a wall 27 such that the light hangs away from the wall for illumination thereof.

The mounting plate can also be arranged such that the elongate body can be rotated thereon. The elongate body will be coupled to and through the mounting plate such that the elongate body can be twisted such that the light rotates about the elongate body enabling a user to position the light from one side to the other relative to the surface.

A photocell can be provided at the base of the light bulb that is at the outer end of the elongate tube or pipe.

The tube or pipe can be formed in two pieces with one piece slidable inside the other and rotatable within the other and locked in place by a thumb screw on the outer piece for adjustment of the length and/or angular orientation of the light relative to the mounting plate.

In the arrangement of FIG. 1, rather than have the electric lead escape from the pipe at the end of the pipe below the plate 15, a hole in one side of the pipe may be provided just above the plate so that the lead is located above the plate and can be fed from the top of the base 5 on which the light fixture is carried.

In FIG. 1, the wire 30 emerges through a hole 31 and surrounding grommet 32 in the side of the stand portion of the tube adjacent to but spaced upwardly from the mounting plate 15.

In FIGS. 2, 3 and 4 the wire emerges from the open bottom end and thus passes through a hole in the mounting plate 15 thus requiring a hole to be drilled in the support 19.

In FIG. 4 the mounting plate 25 is carried on one side of the stand portion of the tube. This can be used for attachment to an upper plate of a mounting spike which extends downwardly from the upper plate into the ground. Thus the plate 25 is clamped to a similar plate at the top of the spike with the spike engaging into the ground so that the structure is engaged into the ground rather than onto a support, in a situation where no suitable support is available.

The electrical connections and arrangements can be provided which are suitable for connection to one hundred and ten volts supply. In the alternative, the arrangements can be designed for twelve volt or twenty-four volt low voltage systems thus avoiding the necessity for hard wiring of the electrical supply. In the alternative, electrical supply can be provided form a photo cell system which is mounted adjacent the electrical lamp.

In FIG. 5 is sown the details of the mounting at the end of the hanging portion 9 of the tube. This computerises a fitting 40 with a screw threaded male section 41 which engages into a female screw thread 42 formed in the end of the hanging portion 9 of the tube. The fitting 40 has a central bore through which the wires pass to the lamp holder 43. The central bore 44 extends through a shaft portion 45 which has an external screw thread 46. A nut 47 engages onto the upper end of the shaft 4 and the second nut 48 engages onto a lower end of the shaft 45 thus holding the fitting in place on the shaft 45. A strain relief element 49 is located on the end of the wire at the nut 47 so that it accommodates any pulling on the wire to prevent the pulling forces from being communicated through to the lamp holder 43.

Under the fitting 40 is provided a mounting dish 50 which attaches to a lamp shade 51 of the glass globe type. The lamp shade is fastened to a threaded coupling 53 at the bottom of the flange portion 54 of the dish. The dish thus has a base 55 which is circular and surround the shaft 45 and extends outwardly beyond the fitting 40 and its edges 56 which extend beyond the end of the tube 9.

The flange portion 54 extends downwardly from the base 55 to define a receptacle 56 within the confines of the mounting dish and within the bowl 51. An annular photocell assembly 57 is provided which fits within the dish underneath the base 55 and surrounding the shaft 45. The annular photocell assembly is a commercially available construction shaped and arranged to fit within the dish 50 so that its peripheral edge 58 is located inwardly of the flange portion 54. A hole 60 is provided in the base 55 to communicate light through a cover 61 over the hole which is transparent through to a photocell receptor 62 on the photocell assembly 57.

The arrangement is arrangement to inexpensively improve the lighting around residential or business or recreational areas. The arrangement provides added security by increasing illumination in these areas.

The device is suitable for lighting patios, decks, fence, picnic tables, barbeques, pathways, driveways, gardens and even within recreation rooms in view of the simple mounting arrangement which provide either the horizontal mounting plate or the vertical mounting plate as required.

The adjustment arrangement shown in FIG. 3 wherein one tube slides within another tube of the stand portion allows adjustment of the height for example from forty six inches to seven five inches. The construction utilizing the dish clamped to the end of the tube provides a waterproof arrangement which is rain resistant.

The bulb 70 screws into the holder 43 and can be of any suitable type for the different voltages as required. Primarily where the arrangement is provided with electrical power from a main supply using hundred and twenty volt service, a fluorescent type bulb of the order of thirteen watts can be used.

The use of the photocell allows the device to be turned on automatically when the ambient light drops to a suitable level.

While embodiments of the present invention has been described in the foregoing, it is to be understood that other embodiments are possible within the scope of the invention. The invention is to be considered limited solely by the scope of the appended claims.

1. A light fixture comprising:
a pipe of constant diameter shaped to define a vertical stand portion;
an arched upper section and a hanging portion which extends downwardly from the arched upper section generally parallel to the stand portion;
a mounting plate attached at or adjacent the bottom of the stand portion for attachment of the stand portion to a support surface;
a wire passing through the pipe for supplying electric power, and;
a lamp attached to the hanging portion for receiving the electric power.

2. A light fixture according to claim 1 wherein the mounting plate is on one side of the stand portion parallel thereto.

3. A light fixture according to claim 1 wherein the mounting plate is on the bottom of the stand portion at right angles thereto.

4. A light fixture according to claim 3 wherein the wire extends through the open end of the stand portion and through the mounting plate.

5. A light fixture according to claim 3 wherein the wire extends through an opening in the side of the stand portion above the mounting plate.

6. A light fixture according to claim 1 wherein on the end of the hanging portion is mounted a fitting carrying a lampshade support dish to which a lamp shade is attached.

7. A light fixture according to claim 6 wherein the lampshade support dish receives therein a photocell assembly.

8. A light fixture according to claim 7 wherein the photocell assembly surrounds the fitting.

9. A light fixture according to claim 8 wherein the photocell assembly is generally annular.

10. A light fixture according to claim 7 wherein the lampshade support dish has a hole therethrough exposing a light receptor of the photocell assembly.
